(19) United States
(12) Patent Application Publication
(10) Pub. No.: US 2017/0058970 A1
(43) Pub. Date: Mar. 2, 2017

(54) FREEWHEEL AND FREEWHEEL ARRANGEMENT COMPRISING SUCH A FREEWHEEL

(71) Applicant: BorgWarner Inc., Auburn Hills, MI (US)

(72) Inventors: Florian Schneider, Heilbad Heiligenstadt (DE); Matthias Gerhard Veit, Oftersheim (DE); Dirk Achim Schmitt, Leimen (St. Ilgen) (DE)

(21) Appl. No.: 15/244,213

(22) Filed: Aug. 23, 2016

(30) Foreign Application Priority Data
Aug. 29, 2015 (DE) 102015011415.8

(51) Int. Cl. F16D 41/066

(52) U.S. Cl. CPC F16D 41/066

(57) ABSTRACT

The present invention relates to a freewheel comprising an outer ring, an inner ring, and at least one clamping element which is between the outer ring and the inner ring, which is moveable from a clamping position into a release position along a race on the outer ring in a first circumferential direction relative to the outer ring, wherein the race has a clamping section, and a release section following the clamping section in the first circumferential direction on which the clamping element is supportable. A first tangent through at least one support point on the clamping section defines a first inner angle, which is greater than 180°, with a second tangent through at least one support point on the release section. In addition, the present invention relates to a freewheel arrangement for a motor vehicle comprising such a freewheel.

### CROSS-REFERENCE TO RELATED APPLICATIONS

This application claims the benefit of German Patent Application No. 102015011415.8 filed Aug. 29, 2015, the disclosure of which is herein incorporated by reference in its entirety.

The invention relates to a freewheel with an outer ring, an inner ring, and at least one clamping element which is between the outer ring and the inner ring and can be moved from a clamping position into a release position and vice versa along a race on the outer ring in a first circumferential direction relative to the outer ring. In addition, the present invention relates to a freewheel arrangement for a motor vehicle comprising such a freewheel.

Freewheel arrangements for motor vehicles are known from practice, and they function to couple the output side of a starter motor to the output side of an internal combustion engine, thus, for example, to a camshaft. The known freewheel arrangements have a freewheel which essentially comprises an outer ring, an inner ring, and multiple clamping elements between the outer ring and the inner ring. The clamping elements may each be moved from a clamping position into a release position and vice versa along a race on the outer ring in a circumferentially direction relative to the outer ring. Within the scope of this movement from the clamping position into the release position and vice versa, the clamping element is supportable on the race of the outer ring. The race thereby has, relative to the first circumferential direction, in which the clamping element is moveable from the clamping position into the release position, in general, a course curved inward in an arc in the radial direction; however, races are also known from practice which have a straight course.

The known freewheels have proven themselves; however, it has been demonstrated that the known freewheels within such a freewheel arrangement, in particular during the starting process and/or in the range of the idle speed, may lead to an increased noise development and oscillations of the system.

It is therefore the object of the present invention to create a freewheel in which the noise and oscillation development is reduced, in particular the noise and oscillation development within the context of a starting process and or in the range of the idle speed. In addition, the underlying object of the present invention is to create a freewheel arrangement with an advantageous freewheel of this type.

The solution to this problem is carried out by the features listed in Patent Claims 1 or 10. Advantageous embodiments of the invention are the subject matter of the subclaims.

The freewheel according to the invention has an outer ring, an inner ring, and at least one clamping element between the outer ring and the inner ring. Thus, a clearance formed in the radial direction between the outer ring and the inner ring for accommodating the clamping element may also be designated as a clamping gap. The clamping element may be, for example, a clamping roller, a clamping body, or the like. Even though a clamping element or at least one clamping element is always discussed here, it is preferred if multiple clamping elements are arranged between the outer ring and the inner ring and are particularly preferably spaced apart uniformly from one another in the circumferential direction. The at least one clamping element may be moved from a clamping position into a release position and vice versa along a race on the outer ring in a first circumferential direction relative to the outer ring. The race on the outer ring thereby has a clamping section and a release section following the clamping section in the first circumferential direction, wherein the clamping element is supportable on the clamping section and on the release section. It is hereby further preferred if a counter-race, formed with an annular shape, is provided on the inner ring. A first tangent through at least one support point, preferably through all support points, on the clamping section, defines a first inner angle, which is greater than 180°, with a second tangent through at least one support point, preferably all support points, on the release section. This angle is here designated as the inner angle, particularly as this is enclosed between the sides of the first and second tangents facing the clamping gap. A support point is here, as well as subsequently, preferably a point on the respective section at which the clamping element is actually supportable.

It has been demonstrated that noise development may be reduced by the cited inner angle, wherein the freewheel tends, in particular, to lower oscillations. This is traced back to the fact that the clamping element is more strongly prevented from reverting into the clamping position after reaching the release section due to the slope of the race in the release section, such that even during the starting process or in the range of the idle speed, an undesired striking of the clamping element on the counter-race of the inner ring may be prevented. These brief strikes on the counter-race of the inner ring appear to occur sometimes, in the case of conventional freewheel arrangements inside of motor vehicles, and to be responsible for noise development when the internal combustion engine is in a compression stroke or in a combustion stroke. In this respect, the release section, which is correspondingly curved opposite to the clamping section, limits the movement range of the clamping element, or shortens the same, in order to prevent the noise and oscillation generating strikings of the clamping element on the inner ring in this operating range of the internal combustion engine, wherein this is traced back to the increase of the radial force component acting outwardly on the clamping element.

In a preferred embodiment of the freewheel according to the invention, the race has a transition section at the transition between the clamping section and the release section, wherein the transition section may have a continuous or discontinuous course. Even though one transition section is always discussed herein at the transition between the clamping section and the release section, it should be clarified that subsections of the transition section may form a subsection of the clamping section and/or the release section. A continuous course of the transition section is hereby basically preferred; however, the transition section may also have a discontinuous course in the simplest configuration variants thereof, for example, a bent course, which would simplify the manufacturing of the freewheel. The continuous course results, in contrast, in a desired fluent movement of the clamping element between the clamping section and the release section, wherein the risk of damage to the transition section and/or the clamping element is also reduced.

In a particularly preferred embodiment of the freewheel according to the invention, the transition section has a course curved outward in the radial direction in relation to the first circumferential direction. In this embodiment, a transition section arched inward in the radial direction may be discussed due to the course curved outward in the radial direction in relation to the first circumferential direction. In this embodiment, it is furthermore preferred if the transition section has a course curved outward in the radial direction in an arch, in a circular arc, or in a spiral. Thus, in this embodiment variant, a transition section curved inward in the radial direction in an arch, in a circular arc, or in a spiral, may also be discussed. The course curved in the circular arc or the spiral has hereby the advantage of the previously discussed continuous course of the transition section, which enables a fluent and/or uniform movement of the clamping element between the clamping section and the release section, and vice versa, and prevents damage to the freewheel.

In an advantageous embodiment of the freewheel according to the invention, the clamping section is designed to be at least partially straight.

Alternatively or supplementally to the previously described embodiment, the clamping section has a course curved inward in the radial direction in relation to the first circumferential direction in another advantageous embodiment of the freewheel according to the invention. It may thus also be stated in this embodiment that the clamping section is formed curved outward in the radial direction. It is also preferred in this embodiment if the clamping section has a course curved inward in an arch, in a circular arc, or in a spiral in the radial direction with respect to the first circumferential direction. Thus, it may also be stated in this embodiment variant, that the clamping section is curved outward in the radial direction in an arch, in a circular arc, or in a spiral. Against the background of reducing noise and oscillations, a course curved inward in the radial direction with respect to the first circumferential direction has proven advantageous, even though the primary effect of the noise and oscillation reduction may be traced back to the previously mentioned inner angle between the first tangent of the clamping section and the second tangent of the release section.

In another advantageous embodiment of the freewheel according to the invention, the release section is designed to be at least partially straight.

Alternatively or supplementally to the previously described embodiment, the release section of the race on the outer ring has a course curved inward in the radial direction in relation to the first circumferential direction in another advantageous embodiment of the freewheel according to the invention. It may thus also be stated that the release section, which has a course curved inward in the radial direction in relation to the first circumferential direction, is curved outward in the radial direction. In this embodiment, it is preferred in turn if the release section has a course curved inward in an arch, in a circular arc, or in a spiral in the radial direction with respect to the first circumferential direction, wherein it may also be stated that the release section is curved outward in the radial direction in an arch, in a circular arc, or in a spiral, in this embodiment variant.

In another preferred embodiment of the freewheel according to the invention, the first inner angle is greater than 185°, wherein it is furthermore preferred if the first inner angle is 190° or more in order to particularly effectively inhibit noise and oscillation development.

In order to particularly effectively suppress noises and oscillations, the first inner angle in a particularly advantageous embodiment of the freewheel according to the invention is dimensioned in such a way that the second tangent defines a release angle on a circumference with a tangent through an intersection point at which a radial extending to a center point of the clamping element crosses the circumference; the release angle is twice as large as the clamping angle of the freewheel, when the clamping element is supported on the support point through which the second tangent extends. The clamping angle of the freewheel hereby designates a predetermined size of the freewheel, which is pre-specified by the dimensioning and shaping of the clamping element, the outer ring, and the inner ring, when the clamping element is located in the clamping position thereof. The center point is preferably the center of gravity of the clamping element and/or arranged on the center axis or axis of rotation of the clamping element. In this embodiment, it has been demonstrated that noises and oscillations may be particularly advantageously suppressed when the cited release angle is at least 1.1 times twice the clamping angle, preferably at least 1.5 times or 2 times twice the clamping angle, particularly preferably at least 2.5 times twice the clamping angle. However, in order to additionally safely achieve a desired movement of the clamping element between the clamping position and the release position, and vice versa, it is additionally preferred in this embodiment, if the release angle is not more than 3 times twice the clamping angle.

In another advantageous embodiment of the freewheel according to the invention, the race on the outer ring additionally has a retaining section, which follows the release section in the first circumferential direction, and on which the clamping element is supportable in order to safely retain or support the clamping element on the race in the first circumferential direction, when said clamping element has released from the counter-race on the inner ring.

According to another advantageous embodiment of the freewheel according to the invention, a third tangent through at least one support point on the retaining section defines a second and/or third inner angle with the second tangent and/or with the first tangent, said second and/or third inner angle is 180° or less. A second and/or third inner angle has hereby proven to be advantageous which is 135°, preferably 100° or less, in order to guarantee a safe support and/or retaining of the clamping element on the retaining section.

In another preferred embodiment of the freewheel according to the invention, the clamping element is designed as a clamping roller. Clamping rollers are understood in this context to be clamping elements with a circular circumference or a circular outer contour, which are additionally preferably designed as cylinders.

In another advantageous embodiment of the freewheel according to the invention, the ratio between a width and an outer diameter of the clamping roller is equal to or less than 1:3, preferably equal to or less than 1:4, particularly preferably equal to or less than 1:5. Due to the width being particularly small relative to the axial extension and the relatively large outer diameter of the clamping roller, said clamping roller is particularly suited for use in connection with the race designed according to the invention with clamping sections and release sections.

In another advantageous embodiment of the freewheel according to the invention, the clamping roller is pretensioned in the clamping position by means of a spring element which is particularly preferably supported or is supportable on the outer ring. In this embodiment, it is further preferred if each individual clamping roller is pretensioned in the clamping position by means of a separate spring element. Basically any spring element is possible for use as the spring element, for example, a helical spring; however, an accordion spring, particularly with a wave-like course in the radial direction, and/or a sheet metal spring has proven advantageous.

The freewheel arrangement according to the invention is conceived of for a motor vehicle and has a freewheel of the previously described type according to the invention. In the freewheel arrangement, an output side of a starter motor, thus for example the starter pinion of a starter motor, is in permanent rotary driving connection with the inner ring of the freewheel, whereas an output side of an internal combustion engine of the motor vehicle is in rotary driving connection, or can be brought into rotary driving connection, with the outer ring of the freewheel. The outer ring is hereby preferably connected or connectable rotationally fixed to the output side of the internal combustion engine.

The invention will be subsequently described in greater detail by means of exemplary embodiments with reference to the attached figures.

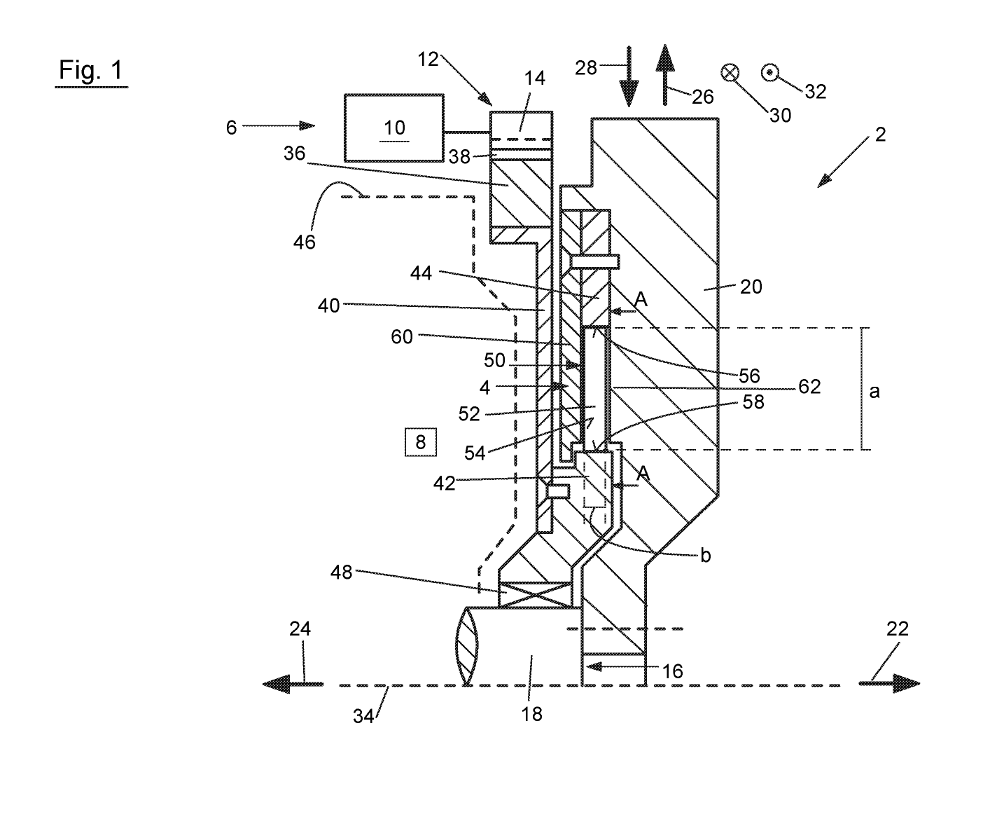

FIG. 1 shows a partial side view of a freewheel arrangement inside of a motor vehicle in a cutaway view;

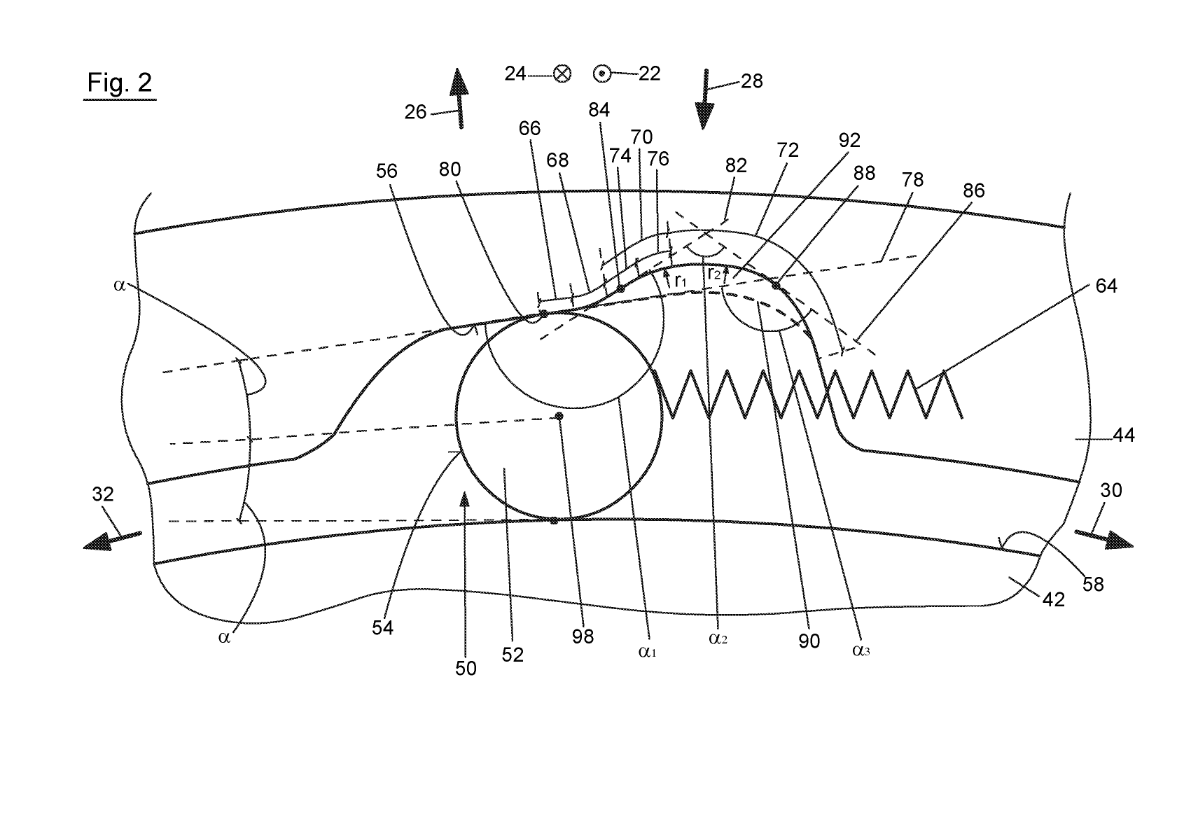

FIG. 2 shows a view along line A-A in FIG. 1 with the freewheel in a first embodiment and the clamping element in the clamping position;

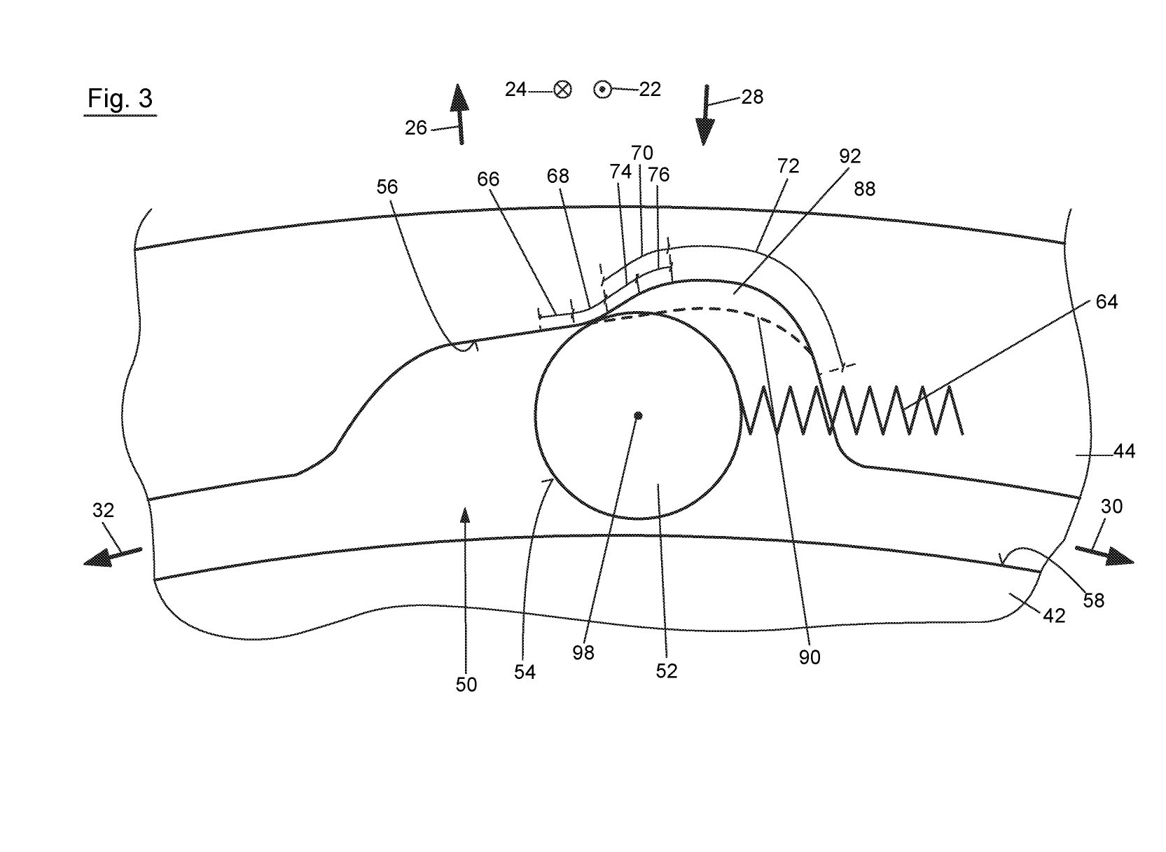

FIG. 3 shows the freewheel from FIG. 2 with the clamping element in a first release position;

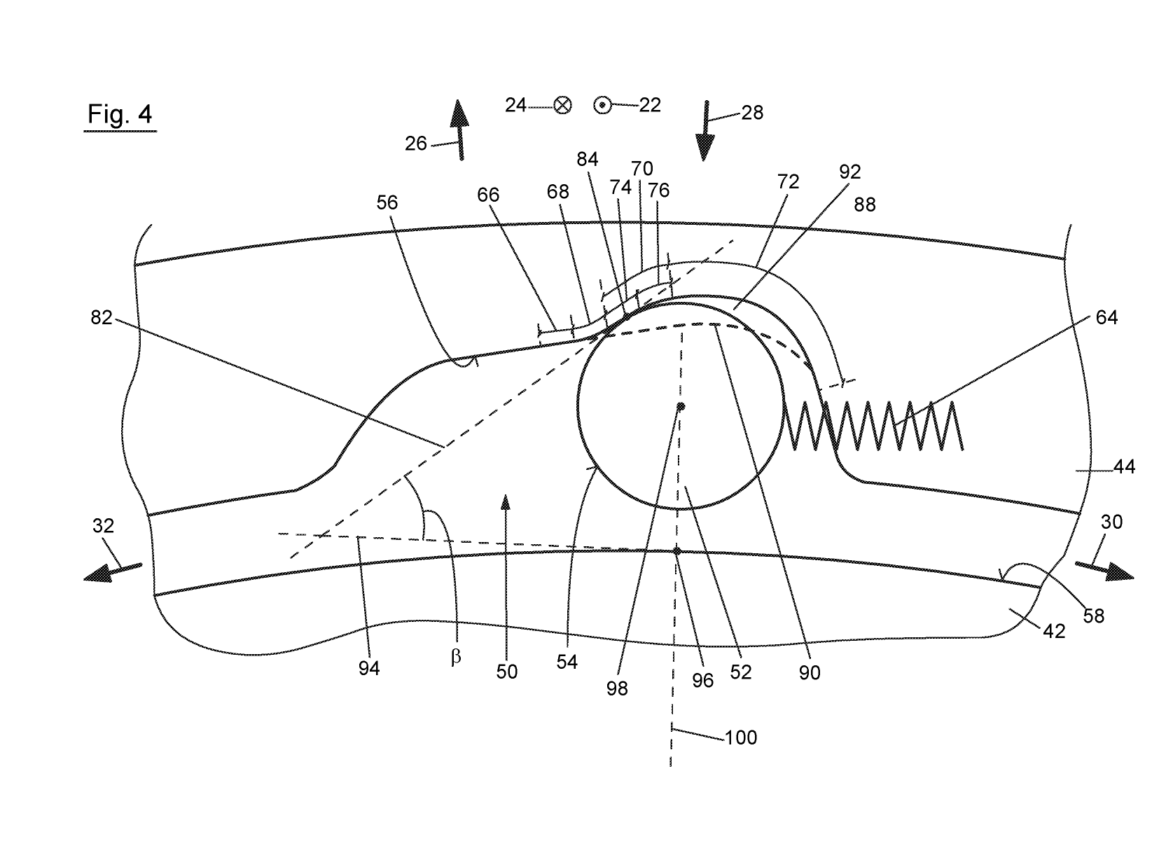

FIG. 4 shows the freewheel from FIG. 3 with the clamping element in a second release position;

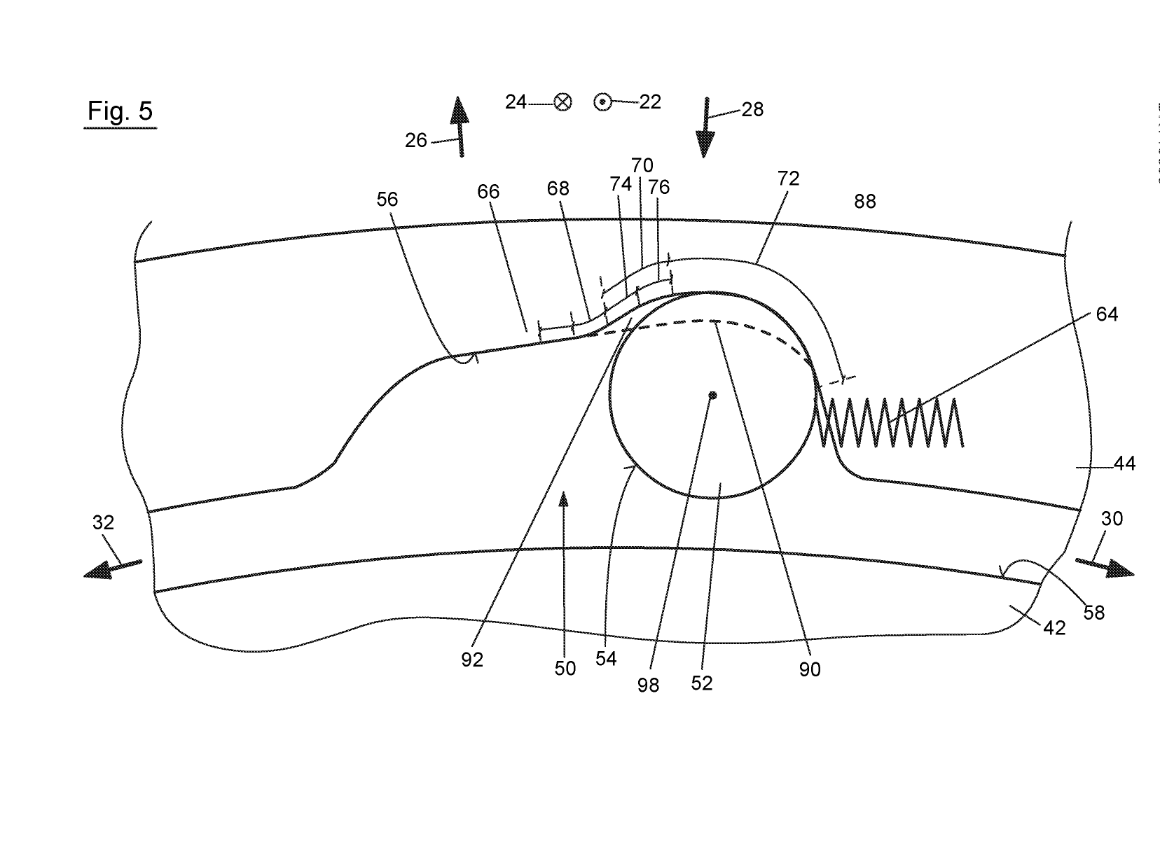

FIG. 5 shows the freewheel from FIG. 4 with the clamping element in a third release position;

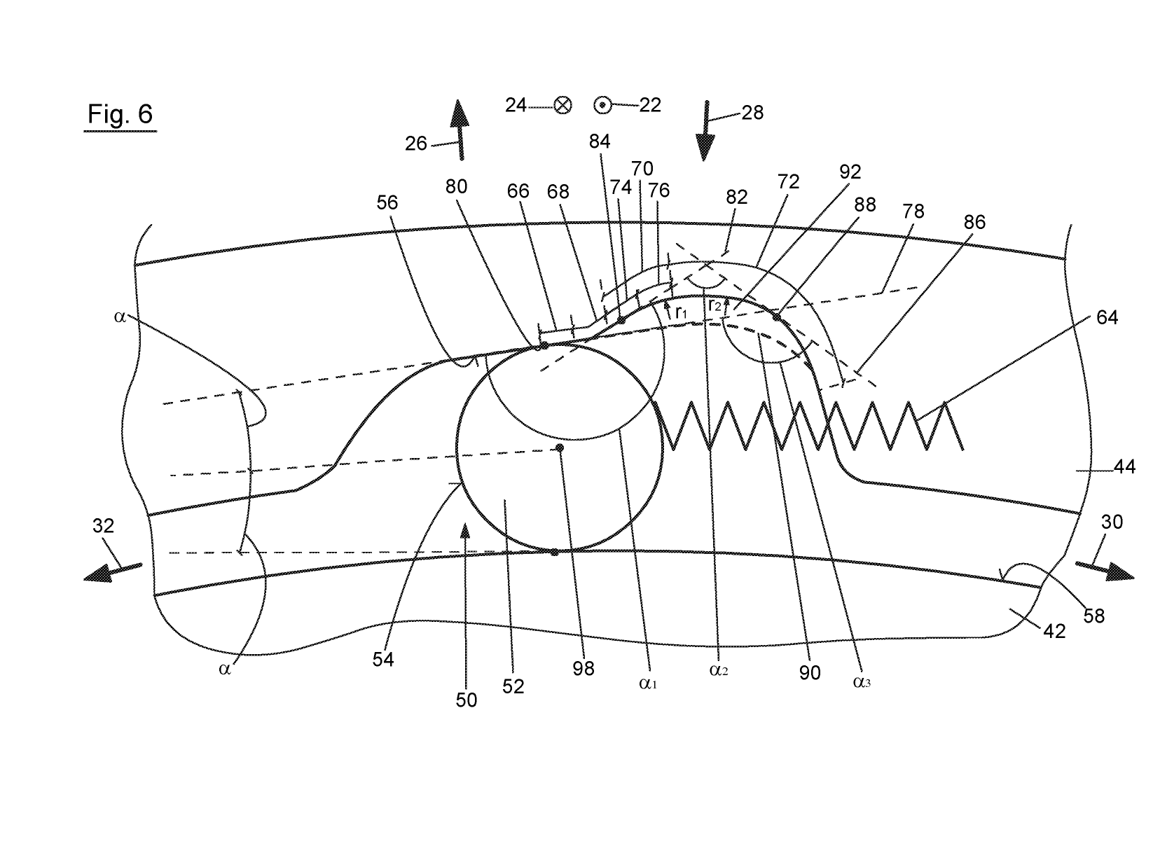

FIG. 6 shows a view along line A-A of FIG. 1 in a second embodiment variant of the freewheel;

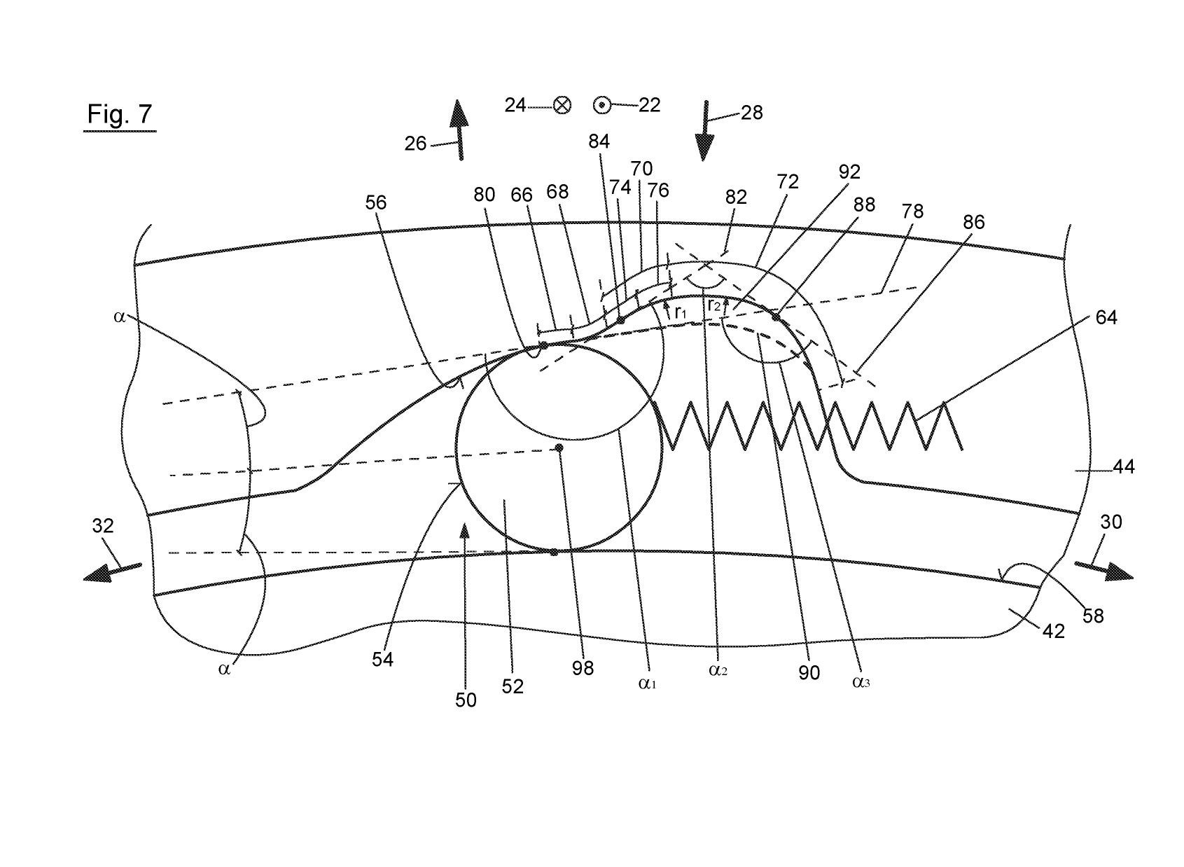

FIG. 7 shows a view along line A-A of FIG. 1 in a third embodiment of the freewheel; and

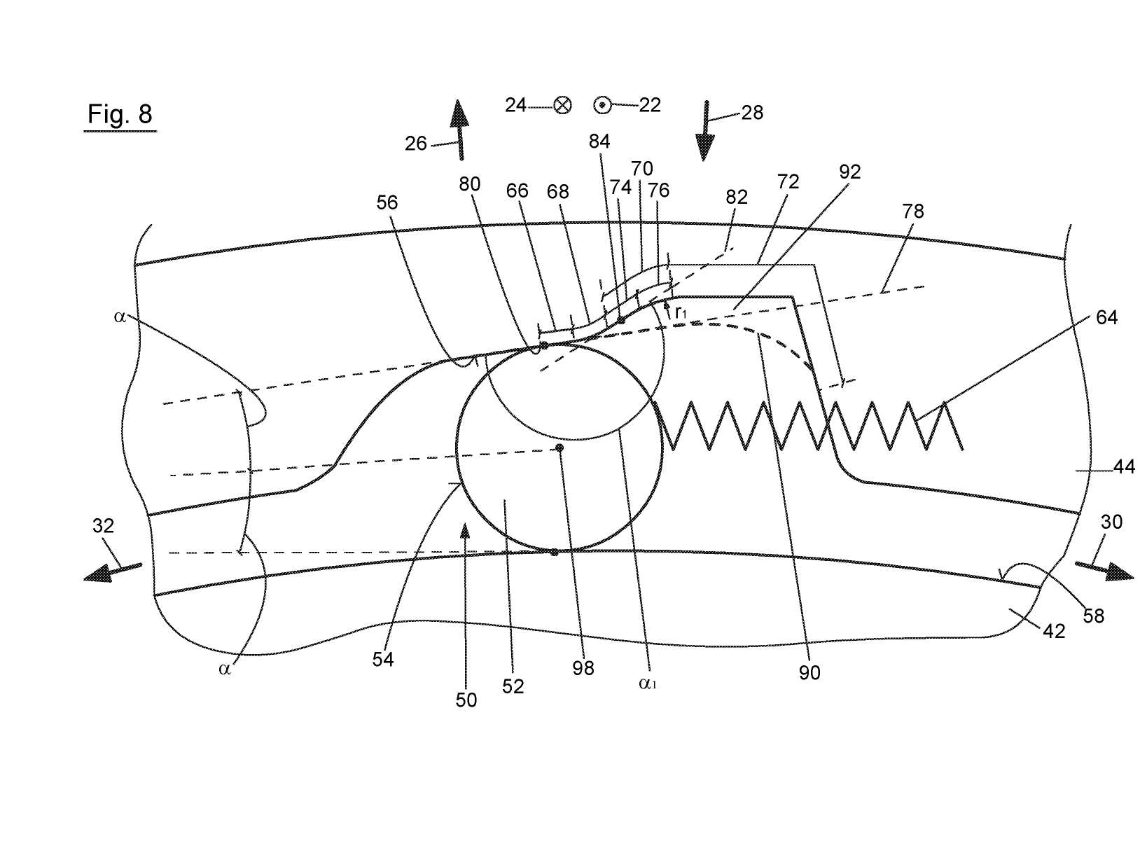

FIG. 8 shows a view along line A-A of FIG. 1 in a fourth embodiment of the freewheel.

FIG. 1 shows a freewheel arrangement 2 inside of a motor vehicle. Freewheel arrangement 2 essentially has a freewheel 4, a starter 6, and an internal combustion engine 8. Starter 6 has a starter motor 10 with an output side 12 which is essentially formed by a starter pinion 14 drivable by starter motor 10. Of internal combustion engine 8, an output side 16 is represented in the form of a driveshaft or crankshaft 18 which is connected rotationally fixed to a flywheel 20 in the embodiment shown. In FIG. 1, the opposing axial directions 22, 24, the opposing radial directions 26, 28, and the opposing circumferential directions 30, 32 of freewheel arrangement 2 and of freewheel 4 are indicated by means of corresponding arrows, wherein circumferential direction 30 is subsequently designated as first circumferential direction 30 and circumferential direction 32 is subsequently designated as second circumferential direction 32. The axis of rotation 34 of output side 16 and of freewheel 4 extends in axial directions 22, 24. First and second circumferential directions 30, 32 may also be designated as first and second directions of rotation.

Output side 12 in the form of starter pinion 14 is arranged in radial direction 26 outside of freewheel 4 such that an output side 12 of starter 6 lying radially exterior may be stated with respect to freewheel 4. Output side 12 of starter motor 10 is permanently in rotary driving connection with a starter gear 36, wherein starter gear 36 has a rotary driving contour 38 for this purpose which is permanently in rotary driving connection with starter pinion 14. Starter gear 36 is connected rotationally fixed to an inner ring 42 of freewheel 4 via a starter wheel 40 which extends, starting from starter gear 36, inward in radial direction 28. An outer ring 44 of freewheel 4 surrounding inner ring 42 of freewheel 4 outwardly in radial direction 26 is, in contrast, connected rotationally fixed to output side 16 of internal combustion engine 8, wherein outer ring 44 in the embodiment shown is connected rotationally fixed to driveshaft 18 forming output side 16 of internal combustion engine 8 via flywheel 20.

Inner ring 42 is supported directly or indirectly in radial directions 26, 28 on output side 16, in this case, on driveshaft 18, to be rotatable in circumferential direction 30, 32. Alternatively, inner ring 42 may also be supported directly or indirectly in radial directions 26, 28 to be rotatable on a stationary housing, for example, on the housing 46 of internal combustion engine 8 indicated in FIG. 1. In order to affect the rotatable support, this is carried out preferably via a radial bearing, particularly preferably via a rolling bearing or plain bearing 48, as this is indicated in FIG. 1. In the embodiment shown, freewheel 4 is designed as a dry-running freewheel. Alternatively, however, freewheel 4 may also be designed as a wet-running freewheel, the supply of coolant and/or lubricant in this case is preferably carried out via the coolant and/or lubricant supply of the internal combustion engine 8.

Inner ring 42 and outer ring 44 are arranged nested in radial directions 26, 28 such that a circumferential clamping gap 50 is formed between the same in circumferential directions 30, 32. Multiple clamping elements 52 are arranged within clamping gap 50 spaced uniformly apart from one another in circumferential directions 30, 32, wherein clamping elements 52 are designed as clamping rollers in the embodiment shown which therefore have a circular circumference or a circular outer contour 54. Outer ring 44 has a race 56 facing inward in radial direction 28 toward clamping elements 52, wherein a race 56 of this type, which has a course deviating from a pure circular arc, is respectively assigned to each of clamping elements 52. Inner ring 42 has, in contrast, a counter-race 58 facing toward clamping elements 52 and outward in radial direction 26. Counter-race 58 designed circumferentially in circumferential directions 30, 32 is designed with a circular shape. Due to race 56 deviating from a circular path on the one side and the circular shape of counter-race 58 on the other side, a clamping gap 50 is created which tapers in second circumferential direction 32 in the region of respective clamping element 52, which will be introduced again in more detail with reference to FIGS. 2 to 8.

Clamping elements 52 designed as clamping rollers have a width b and an outer diameter a with respect to axial directions 22, 24. The ratio between width b and outer diameter a of the respective clamping elements 52 designed as clamping rollers is equal to or less than 1:3, preferably equal to or less than 1:4, particularly preferably equal to or less than 1:5. In other words, coin shaped clamping elements 52 or clamping rollers may also be discussed which enable a particularly short axial structure of freewheel 4. Clamping gap 50 is delimited in axial direction 22 by a first side wall 60 and in axial direction 24 by a second side wall 62, wherein first side wall 60 is formed in the embodiment shown by a section of flywheel 20, whereas second side wall 62 is formed separately from flywheel 20 and as an annular disk. First side wall 60 and second side wall 62 are fixed rotationally fixed to outer ring 44 of freewheel 4, which may be carried out, by way of example, by means of the screw connection (no reference numeral) shown in FIG. 1.

The further structure of freewheel arrangement 2 and freewheel 4 in FIG. 1 will be subsequently described with reference to FIGS. 1 to 5, wherein FIGS. 2 to 5 show a first embodiment of freewheel 4.

Each clamping element 52 may be moved along race 56 on outer ring 44 in first circumferential direction 30 relative to outer ring 44 from a clamping position, which is shown in FIG. 2, into a release position, which is shown in FIGS. 3 to 5. Clamping element 52 is thereby moved from the clamping position into the release position counter to the reset force of a spring element 64, which is supported or is supportable on the one side in first circumferential direction 30 on outer ring 44 and on the other side in second circumferential direction 32 on clamping element 52. In other words, clamping element 52 designed as a clamping roller is pretensioned by spring element 64 in the clamping position shown in FIG. 2.

In the clamping position shown in FIG. 2, outer contour 54 of clamping element 52 is supported both on race 56 and on counter-race 58, wherein a rotation of outer ring 44 in first circumferential direction 30 relative to inner ring 42 is prevented. In the clamping position, outer ring 44 and thus also output side 16 of internal combustion engine 8 in the form of driveshaft 18 may be driven with the aid of flywheel 20 by starter 6, which rotates inner ring 42 of freewheel 4 in second circumferential direction 32 by means of starter gear 36 and starter wheel 40. If internal combustion engine 8 starts as a result of this starting process, such that outer ring 44 driven by output side 16 of internal combustion engine 8 overtakes inner ring 42 of freewheel 4 in second circumferential direction 32, then clamping element 52 moves along race 56 as a result of centrifugal and inertial forces into the release position shown in FIGS. 3 to 5. Therefore, freewheel 4 in the basic structure is a so-called one-way coupling.

Race 56 on outer ring 44 has essentially a clamping section 66, a transition section 68 following clamping section 66 in first circumferential direction 30, a release section 70 following transition section 68 in first circumferential direction 30, and a retaining section 72 following release section 70 in first circumferential direction, wherein transition section 68 is provided at the transition between clamping section 66 and release section 70. Transition section 68 may thereby be assigned partially or completely to clamping section 66 and/or partially or completely to release section 70. Clamping element 52 is supportable via its outer contour 54 at support points on clamping section 66, transition section 68, release section 70, and retaining section 72 respectively. Support points are thereby preferably understood as those points on the respective section, at which the clamping element is actually supportable for structural reasons.

In the first embodiment according to FIGS. 2 to 5, clamping section 66 is designed to be at least partially or completely straight. Alternatively or supplementally, however, clamping section 66 may also have a curved course, as is indicated in FIG. 7. Thus, clamping section 66 in the embodiment according to FIG. 7 has a course curved inward in radial direction 28 in an arch, in a circular arc, or in a spiral with respect to first circumferential direction 30. It may also be stated here that clamping section is designed, according to the embodiment according to FIG. 7, curved outward in radial direction 26, preferably in an arch, in a circular arc, or in a spiral.

Transition section 68 may basically have a continuous course, as this is shown in the embodiments according to FIGS. 2 to 5, 7 and 8, or a discontinuous course, as this is indicated in FIG. 6 in the context of a second embodiment of freewheel 4. In this second embodiment, transition section 68 analogously has a bent course. Regardless of whether transition section 68 has a continuous or discontinuous course, transition sections 68 in all of the embodiments shown according to FIGS. 2 to 8 have a course curved outward in radial direction 26 relative to first circumferential direction 30, wherein it may also be stated that transition section 68—continuous or discontinuous—is curved inward in radial direction 28. It is hereby preferred if transition section 68, as is shown in FIGS. 2 to 5 and 7 to 8, has a course curved outward in radial direction 26 in an arch, in a circular arc, or in a spiral, wherein it may also be stated that transition section 68 is curved inward in radial direction 28 in an arch, in a circular arc, or in a spiral in these embodiments.

Release section 70 may be designed to be at least partially or completely straight. Alternatively or supplementally, however, release section 70 may also have a course curved inward in radial direction 28, preferably in an arch, in a circular arc, or in a spiral with respect to first circumferential direction 30. In other words, release section 70 may be designed curved outward in radial direction 26, preferably in an arch, in a circular arc, or in a spiral. In the embodiments shown, release section 70 has a first subsection 74 and a second subsection 76 following first subsection 74 in first circumferential direction 30, wherein first subsection 74 is designed to be straight, whereas second subsection 76 has a course curved inward in radial direction 28, preferably in an arch, in a circular arc, or in a spiral with respect to first circumferential direction 30.

Retaining section 72 following release section 70 has, in turn a course curved inward in radial direction 28, preferably in an arch, in a circular arc, or in a spiral with respect to first circumferential direction 30, wherein it may be stated in turn that retaining section 72 has a course a course curved outward in radial direction 26, preferably in an arch, in a circular arc, or in a spiral. In the embodiments shown according to FIGS. 2 to 8, both second subsection 76 of release section 70 and retaining section 72 are curved in a circular arc, wherein this has a circular arc radius r₁ or r₂. Circular arc radius r₁ preferably corresponds to circular arc radius r₂. Alternatively, however, circular arc radius r₂ may be designed to be greater than circular arc radius r₁. It is also preferred if circular arc radius r₂ of the circular arc formed by retaining section 72, regardless of whether this corresponds to circular arc radius r₁ of second subsection 76 or whether second subsection 76 is even designed as a circular arc, is greater than the radius of clamping element 52 designed as a clamping roller, such that preferably a/2<r₂ applies. It should also be noted at this point that release section 70 may be formed completely from straight first subsection 74 or from curved second subsection 76, even though the division into first and second subsections 74, 76 shown in FIGS. 2 to 8 is preferred.

In order to effectively suppress noise development during the starting process and/or in the range or the idle speed, a first tangent 78 through at least one support point 80 on clamping section 66 of race 56 defines a first inner angle α 1 , which is greater than 180°, with a second tangent 82 through at least one support point 84 on release section 70. It has hereby proven advantageous, if the cited first inner angle α 1 is greater than 185°, particularly preferably 190° or more. It is also preferred if the cited first inner angle α 1 exists proportionally between all possible support points of clamping element 52 on clamping section 66 and all possible support points on release section 70.

In addition, retaining section 72 is designed in such a way that a third tangent 86 through at least one support point 88 on retaining section 72 defines a second inner angle α2 and/or a third inner angle α3, which is 180° or less, with second tangent 82 and/or with first tangent 78.

On the basis of the preceding description, it is apparent that race 56 has a course, on the basis of correspondingly formed first inner angle α1, which deviates from the conventional course 90, indicated in the figures with dashed lines, in order to effectively suppress noise development during the starting process and/or in the range of idle speed, wherein, in contrast to conventional course 90, a depression 92 is analogously created in the region of release section 70 and retaining section 72. The functionality of freewheel arrangement 2 and freewheel 4 shall be subsequently introduced in greater detail with reference to FIGS. 2 to 5.

In FIG. 2, clamping element 52 is in the clamping position thereof. In the clamping position of clamping element 52, outer contour 52 [sic: should read 54] thereof is supported both in radial direction 26 outward on clamping section 66 and in radial direction 28 inward on counter-race 58, wherein clamping element is retained in the clamping position via spring element 64. For structural reasons, freewheel 4 has a predetermined clamping angle a, which is indicated twice in FIG. 2. During the starting process, inner ring 42 is initially driven in second circumferential direction 32 via starter 6, wherein, due to the clamping position of clamping element 52, a rotary driving connection exists between inner ring 42 and outer ring 44 by means of clamping element 52. Therefore, outer ring 44 and, via outer ring 44, flywheel 20 and output side 16 of internal combustion engine 8, and internal combustion engine 8 or driveshaft 18 thereof, are also driven.

In the combustion cycles of internal combustion engine 8, outer ring 44 is additionally driven—somewhat intermittently—in second circumferential direction 32, such that clamping element 52 moves along race 56, more exactly stated, along clamping section 66, transition section 68 (FIG. 3), release section 70 (FIG. 4), and retaining section 72 (FIG. 5), wherein this occurs as a result of centrifugal and inertial forces counter to the reset force of spring element 64.

In the compression cycles of internal combustion engine 8, however, the speed of outer ring 44 rotating in second circumferential direction 32 is reduced such that clamping element 52 is moved back in second circumferential direction 32 relative to outer ring 44 due to the reset force of spring element 64 and due to the decrease in the centrifugal force affecting clamping element 52. However, in the course of this movement of clamping element 52 in second circumferential direction 32 relative to outer ring 44, clamping element 52 supports itself on release section 70 of race 56, as this is shown in FIG. 4, wherein the previously mentioned first inner angle al, which is designed to be greater than 180°, prevents a further movement of clamping element 52 in second circumferential direction 32 relative to outer ring 44, such that it may be avoided that clamping element 52 is moved further along race 56 in second circumferential direction 32 relative to outer ring 44 and ultimately strikes counter-race 58 of inner ring 42 inward in radial direction 28. Thus, both noise development and also oscillation development may be prevented by this means.

In this context, it has proven particularly advantageous if previously mentioned second tangent 82 (see also FIG. 4) through support point 84 defines a release angle β on a circumference with a tangent 94 through an intersection point 96, at which a radial 100 extending to a center point 98 of clamping element 98 intersects the circumference—here the circular counter-race 58—, which angle β is greater than twice clamping angle α of freewheel 4 when clamping element 52 is supported on support point 84, through which second tangent 82 extends. It has additionally proven hereby advantageous, if release angle β is at least 1.1 times or 1.5 times twice clamping angle a, particularly preferably at least 2 times or 2.5 times twice clamping angle α. As an upper limit for release angle β, however, it has proven advantageous if release angle β is not more than 3 times twice clamping angle α.

The preceding description of the first embodiment according to FIGS. 1 to 5 applies analogously to the additional embodiments according to FIGS. 6, 7, and 8, such that reference is made with respect to the preceding description. Whereas reference has already been made to the second embodiment according to FIG. 6 and to the third embodiment according to FIG. 7, fourth embodiment according to FIG. 8 shall subsequently be supplementally introduced. In contrast to the preceding embodiments, retaining section 72 in the fourth embodiment according to FIG. 8 is designed to be essentially straight. Thus, retaining section 72 has two straight subsections, connected to each other, however, at a bend. In general, the preceding description of embodiments 1 to 3 applies accordingly.

### LIST OF REFERENCE NUMERALS

2 Freewheel arrangement
4 Freewheel
6 Starter
8 Internal combustion engine
10 Starter motor
12 Output side
14 Starter pinion
16 Output side
18 Driveshaft
20 Flywheel
22 Axial direction
24 Axial direction
26 Radial direction
28 Radial direction
30 First circumferential direction
32 Second circumferential direction
34 Axis of rotation
36 Starter gear
38 Rotary driving contour
40 Starter wheel
42 Inner ring
44 Outer ring
46 Housing
48 Roller bearing or plain bearing
50 Clamping gap
52 Clamping element
54 Outer contour
56 Race
58 Counter-race
60 First side wall
62 Second side wall
64 Spring element
66 Clamping section
68 Transition section
70 Release section
72 Retaining section
74 First subsection
76 Second subsection
78 First tangent
80 Support point
82 Second tangent
84 Support point
86 Third tangent
88 Support point
90 Conventional course
92 Depression
94 Tangent
96 Intersection point
98 Center
100 Radial
a Outer diameter
α Predetermined clamping angle
α1 First inner angle
α2 Second inner angle
α3 Third inner angle
b Width
βRelease angle
r₁ Circular arc radius
r₂ Circular arc radius

1. A freewheel comprising an outer ring, an inner ring, and at least one clamping element which is between the outer ring and the inner ring, which is moveable from a clamping position into a release position along a race on the outer ring in a first circumferential direction relative to the outer ring, wherein the race has a clamping section, and a release section following the clamping section in the first circumferential direction on which the clamping element is supportable, characterized in that a first tangent through at least one support point on the clamping section defines a first inner angle, which is greater than 180°, with a second tangent through at least one support point on the release section.

2. The freewheel as recited in claim 1, wherein the race has a transition section at the transition between the clamping section and the release section , wherein the transition section has a continuous or discontinuous course.

3. The freewheel according to claim 2, wherein the transition section has a course curved outward in the radial direction with respect to the first circumferential direction, preferably in an arch, a circular arc, or a spiral.

4. The freewheel according to claim 1, wherein the clamping section is designed at least partially straight and/or has a course curved inward in the radial direction with respect to the first circumferential direction, preferably in an arch, a circular arc, or a spiral.

5. The freewheel according to claim 1, wherein the release section is designed at least partially straight and/or has a course curved inward in the radial direction with respect to the first circumferential direction, preferably in an arch, a circular arc, or a spiral.

6. The freewheel according to claim 1, wherein the first inner angle is greater than 185°, is preferably 190° or more.

7. The freewheel according to claim 1, wherein the second tangent defines a release angle on a circumference with a tangent through an intersection, at which a radial extending to a center of the clamping element crosses the circumference, said release angle being greater than twice the clamping angle of the freewheel when the clamping element is supported on the support point, through which the second tangent extends, wherein the release angle is preferably at least 1.1 times or 1.5 times twice the clamping angle, particularly preferably at least 2 times or 2.5 times twice the clamping angle, if necessary, not more than 3 times twice the clamping angle.

8. The freewheel according to claim 1, wherein the race additionally has a retaining section following the release section in the first circumferential direction, on which retaining section the clamping element is supportable, wherein a third tangent defines a second and/or a third inner angle, which is 180° or less, with the second tangent and/or with the first tangent.

9. The freewheel according to claim 1, wherein the clamping element is designed as a clamping roller, wherein the ratio between a width and an outer diameter of the clamping roller is preferably equal to or less than 1:3, particularly preferably equal to or less than 1:4 or 1:5, and/or the clamping roller is pretensioned in the clamping position by means of a spring element which is preferably supported or is supportable on the outer ring.

10. A freewheel arrangement for a motor vehicle comprising a freewheel according to claim 1, wherein an output side of a starter motor is in permanent rotary driving connection with the inner ring, whereas an output side of an internal combustion engine of the motor vehicle is in or can be brought into rotary driving connection with the outer ring.
